(19) United States
(12) Patent Application Publication
(10) Pub. No.: US 2008/0175016 A1
(43) Pub. Date: Jul. 24, 2008

(54) Illumination device for vehicle

(76) Inventor: Shih Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/655,106

(22) Filed: Jan. 19, 2007

(51) Int. Cl. F21V 21/14

(52) U.S. Cl. 362/530

(57) ABSTRACT

An illuminating device for a vehicle includes a light device, a motor, and a rotational device. The light device includes a light housing having a bottom portion with a through-hole defined by a peripheral edge. A support plate extends from the peripheral edge of the through-hole and made of a material different from that of the light housing. The support plate and the light housing are integrally formed, thereby providing a reinforced support structure when the rotational device is mounted to the peripheral edge of the through-hole. The rotational device is coupled with the motor, and the motor drives the light housing to turn when the rotational device is fixed to a vehicle.

### BACKGROUND OF THE INVENTION

1. Field of the Invention

The present invention relates to an illumination device and, more particularly, to an illumination device that can be mounted to a vehicle.

2. Description of the Related Art

Outdoor recreative activities such as camping, barbecue, etc. are popular, and recreation vans and tents provide convenience to recreationists. The lights on a vehicle may provide illumination in the night. The recreationists sometimes must build a campfire or use a flashlight or a mobile illuminating device, for the lights such as headlights, taillights, and turning signals are fixed on the vehicle. The campfire is, however, also fixed, and the flashlight and the mobile illuminating device have limited capacity in electricity. It is, therefore, a need in an illuminating device that can be mounted on a vehicle and adjustable in the illumination orientation for providing convenience to outdoor activities.

### SUMMARY OF THE INVENTION

An illuminating device for a vehicle in accordance with the present invention includes a light device, a motor, and a rotational device. The light device includes a light housing having a bottom portion with a through-hole defined by a peripheral edge. A support plate extends from the peripheral edge of the through-hole and made of a material different from that of the light housing. The support plate and the light housing are integrally formed, thereby providing a reinforced support structure when the rotational device is mounted to the peripheral edge of the through-hole. The rotational device is coupled with the motor, and the motor drives the light housing to turn when the rotational device is fixed to a vehicle.

In a preferred form, the rotational device includes an axle block, a fixing block, a support screw, a swaying member, and a swaying seat. The axle block is fixed to a bottom of the motor and coupled with a rotational shaft of the motor. The axle block includes an engaging groove in a bottom thereof. The fixing block is fixed to the axle block and includes a protrusion securely engaged in the engaging groove of the axle block. The support screw includes an upper end received in a hollow portion of the fixing block. The swaying member includes a hollow disc having a flange on an outer periphery thereof. The flange includes a plurality of through-holes, with screws extending through the through-holes of the flange into a plurality of holes in the fixing block. The swaying member includes an arcuate plate on a bottom thereof. The arcuate plate includes a plurality of arcuate ribs. The swaying seat includes a hollow disc having a bowl-like compartment in an upper portion thereof. A plurality of arcuate grooves are defined in an inner peripheral wall defining the bowl-like compartment. The arcuate plate of the swaying member is received in the bowl-like compartment of the swaying seat, with the arcuate ribs being slidably received in the arcuate grooves of the swaying seat. The support screw extends through the swaying member and the swaying seat and has an exposed section outside the swaying seat, with a washer and a nut mounted to the exposed section to allow the support screw to be fixed to the vehicle.

Preferably, a buffering device is provided in a bottom portion of the swaying seat. In a preferred form, the buffering device includes upper and lower cushions in intimate contact with each other and made of soft, tough material.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an illuminating device for a vehicle in accordance with the present invention.

FIG. 2 is an exploded perspective view of the illuminating device in accordance with the present invention.

FIG. 3 is an exploded perspective view illustrating a motor, an axle block, and a fixing block of the illuminating device in accordance with the present invention.

FIG. 4 is a partially sectioned side view of the illuminating device in accordance with the present invention.

FIG. 5 is a schematic top view illustrating rotational movement of the illuminating device in accordance with the present invention.

FIG. 6 is a view similar to FIG. 4, illustrating forward/rearward adjustment in an inclination angle of the illuminating device in accordance with the present invention.

### DETAILED DESCRIPTION OF THE PREFERRED EMBODIMENT

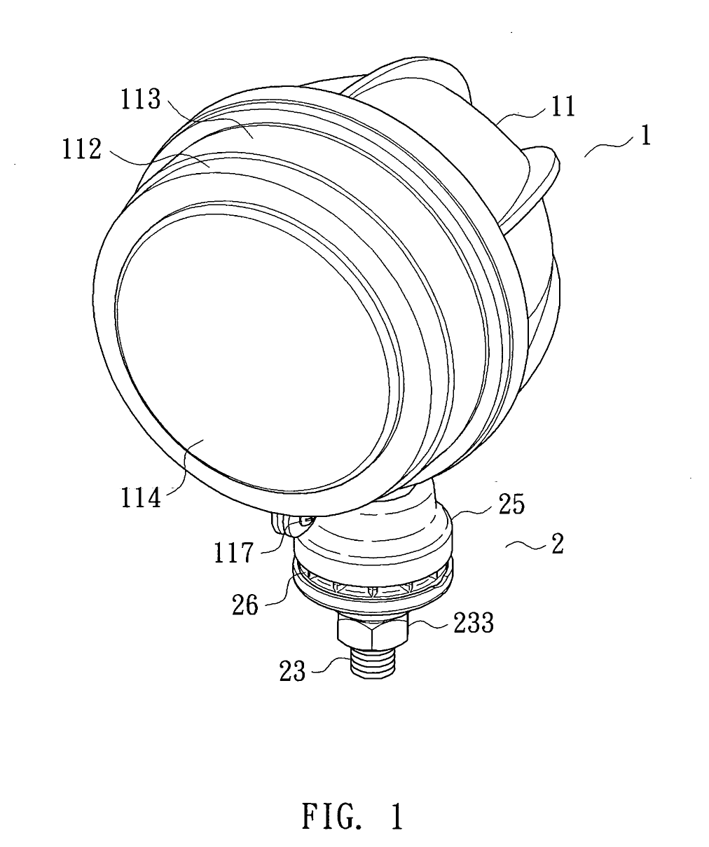

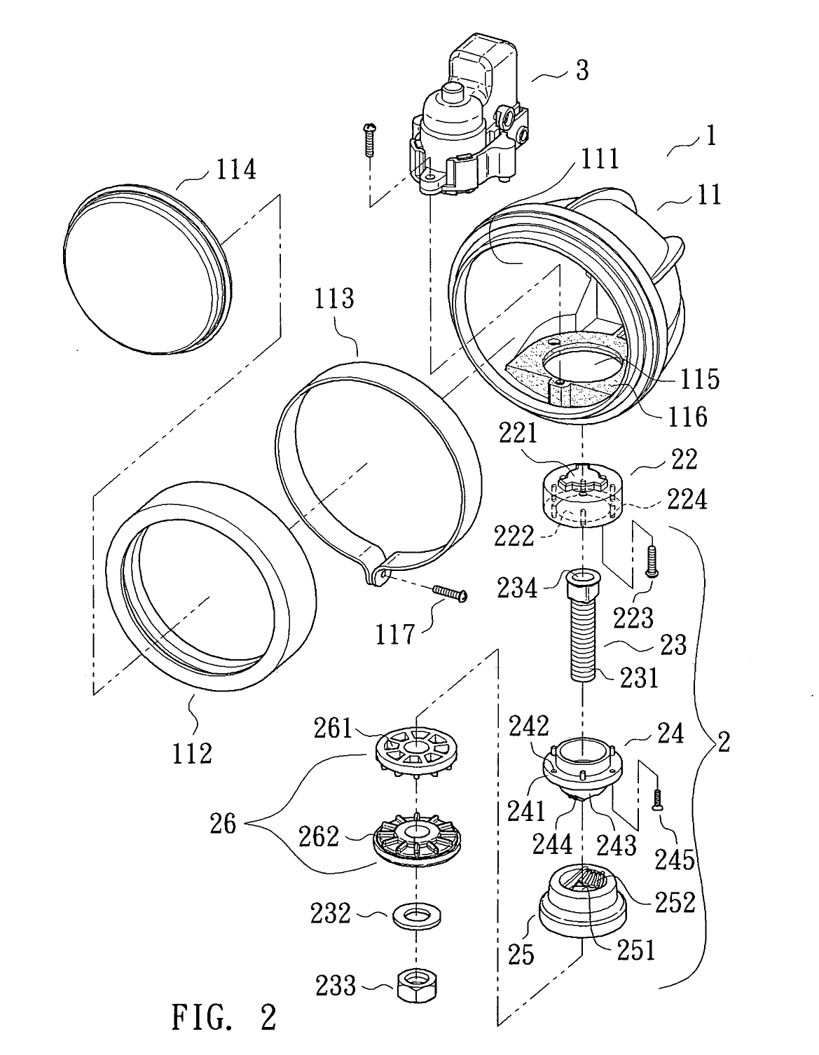

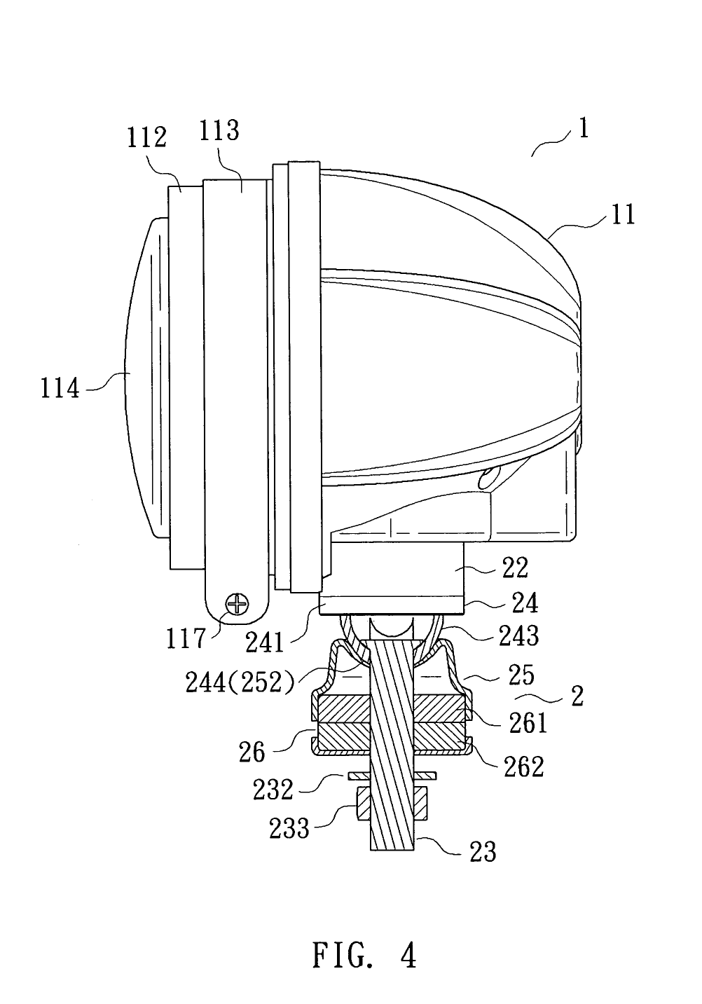

Referring to FIGS. 1, 2, and 4, an illuminating device for a vehicle in accordance with the present invention comprises a light device 1, a rotational device 2, and a motor 3. The light device 1 includes a light housing 11 and an illuminating unit (not shown). The light housing 11 includes an opening 111 defined by a peripheral wall to which a ring 112 is fixed by a clamping ring 113 and a screw 117. A light shade 114 is mounted in the ring 112 and faces the opening 111.

The light housing 11 includes a through-hole 115 in a bottom portion thereof. A support plate 116 extends from a peripheral edge of the through-hole 115 and made of a material different from that of the light housing 11. The support plate 116 and the light housing 11 are integrally formed. A reinforced support structure is provided when the rotational device 2 is mounted to the peripheral edge of the through-hole 115.

The rotational device 2 is coupled with a rotational shaft (not shown) of a motor 3 mounted in the light housing 11. The rotational device 2 can be fixed to a vehicle and drivable by the motor 3 to turn the light housing 11.

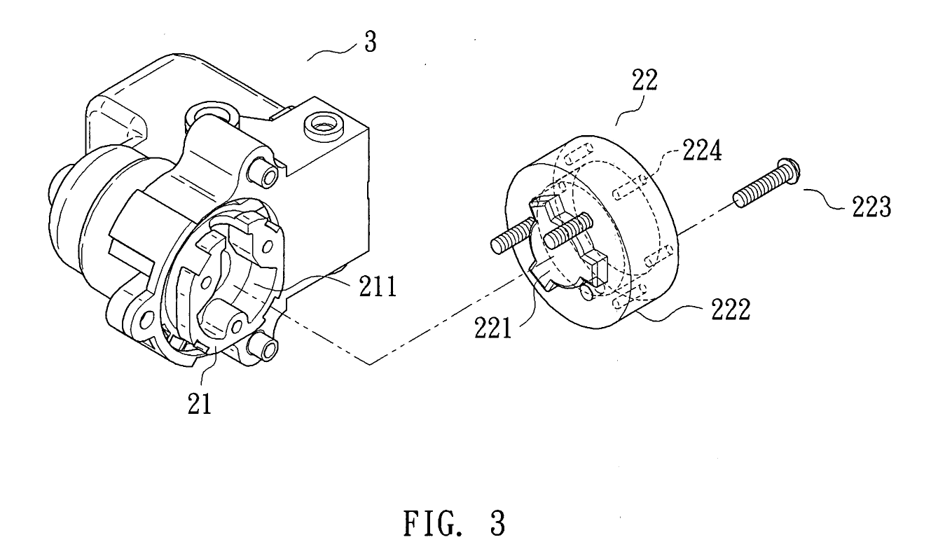

In the embodiment shown, the rotational device 2 includes an axle block 21 (see FIG. 3) that is mounted to a bottom of the motor 3 and coupled with the rotational shaft of the motor 3 to allow joint rotation of the axle block 21 and the rotational shaft. The axle block 21 includes an engaging groove 211 in a bottom thereof.

The rotational device 2 further includes a fixing block 22 having a hollow portion 222. The fixing block 22 is fixed to the axle block 21 by extending screws 223 through the fixing block 22 into holes (not labeled) in the axle block 21. A protrusion 221 is provided on top of the fixing block 22 and engaged in the engaging groove 211 of the axle block 21, thereby allowing joint rotation of the axle block 21 and the fixing block 22.

The rotational device 2 further includes a support screw 23 having an upper end received in the hollow portion 222 of the fixing block 22 and extending downward in sequence through a swaying member 24 and a swaying seat 25. A washer 232 and a nut 233 can be mounted to an exposed section 231 of the support screw 23 outside the swaying seat 25, allowing the support screw 23 to be fixed to any desired position of a vehicle. The support screw 23 further includes a wire hole 234 through which wires extend to be in electrical connection with a power source of the vehicle.

The swaying member 24 is in the form of a hollow disc having a flange 241 on an outer periphery thereof. The flange 241 includes a plurality of through-holes 242. Screws 245 extend through the through-holes 242 of the flange 241 and holes 224 in the fixing block 22, thereby securing the fixing block 22 and the swaying member 24 together. An arcuate plate 243 is provided on a bottom of the swaying member 24 and includes a plurality of arcuate ribs 244 on a face thereof.

The swaying seat 25 is in the form of a hollow disc and includes a bowl-like compartment 251 in an upper portion thereof for receiving the arcuate plate 243 of the swaying member 24. A plurality of arcuate grooves 252 are defined in an inner peripheral wall defining the bowl-like compartment 251 for respectively receiving the arcuate ribs 244. A buffering device 26 is mounted in a bottom portion of the swaying seat 25. The buffering device 26 includes upper and lower cushions 261 and 262 in intimate contact with each other and made of soft, tough material. Vibrations occur while the vehicle is running. The buffering device 26 avoids damage to the illuminating device resulting from excessive vibrations, thereby prolonging the life of the illuminating device.

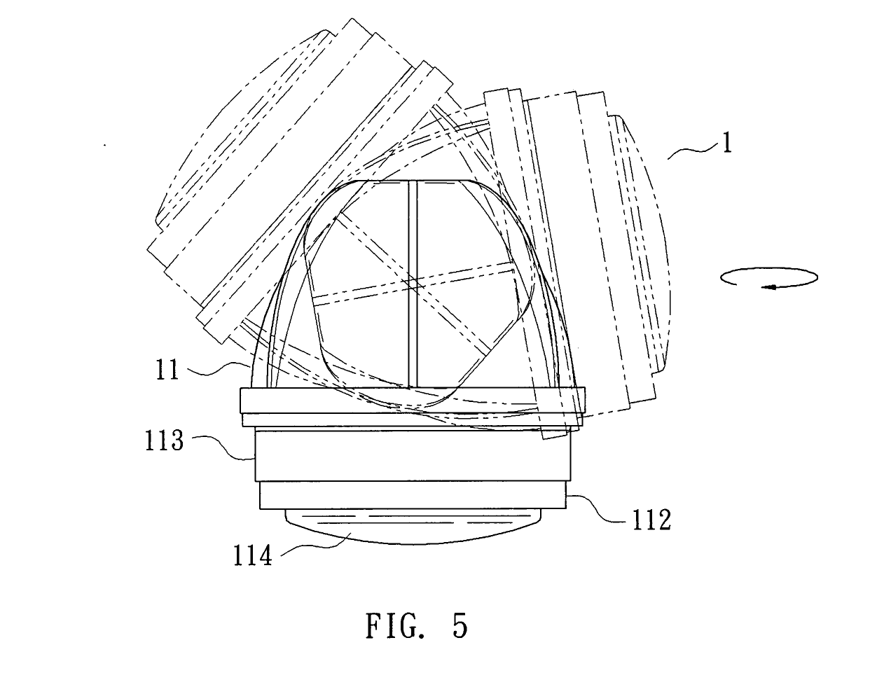

With reference to FIG. 5, when the power source is turned on, the illuminating unit of the illuminating device is turned on while the motor 3 is activated. The axle block 21 coupled with the rotational shaft of the motor 3 turns together with the rotational shaft, which, in turn, drives the fixing block 22 that is fixed to the axle block 21. Since the support screw 23 whose upper end is received in the hollow portion 222 of the fixing block 22 extends downward in sequence through the swaying member 24 and the swaying seat 25, the swaying member 24 and the swaying seat 25 are securely clamped in an axial direction. Hence, the whole rotational device 2 rotates together with the rotational shaft of the motor 3. Nevertheless, the rotational device 2 is fixed to the vehicle. As a result, the motor 3 and the light unit 1 turn relative to the fixed rotational device 2.

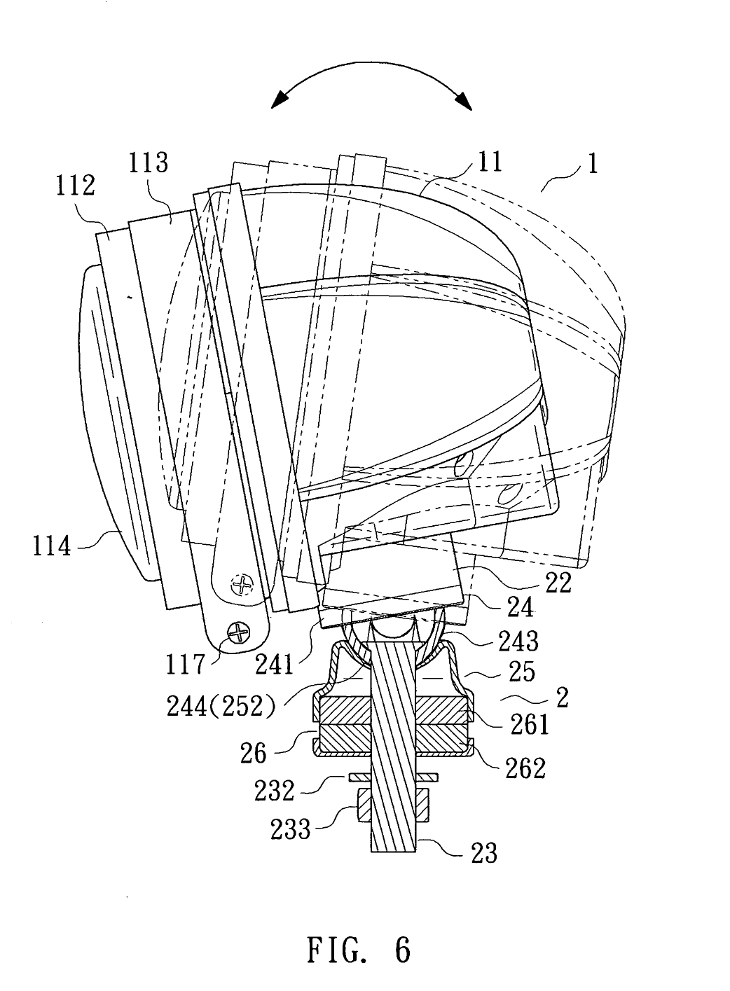

With reference to FIG. 6, since the arcuate ribs 244 of the arcuate plate 243 of the swaying member 24 are slidably received in the arcuate grooves 252 of the bowl-like compartment 251 of the swaying seat 25, the swaying member 24 can be manually adjusted to a desired inclination angle for adjusting the illuminating angle.

Although a specific embodiment has been illustrated and described, numerous modifications and variations are still possible without departing from the essence of the invention. The scope of the invention is limited by the accompanying claims.

What is claimed is:

1. An illuminating device for a vehicle, comprising a light device, a motor, and a rotational device, the light device including a light housing having a bottom portion with a through-hole defined by a peripheral edge, a support plate extending from the peripheral edge of the through-hole, the support plate being made of a material different from that of the light housing, the support plate and the light housing being integrally formed, thereby providing a reinforced support structure when the rotational device is mounted to the peripheral edge of the through-hole;
with the rotational device being coupled with the motor, and with the motor driving the light housing to turn when the rotational device is fixed to a vehicle.

2. The illuminating device for a vehicle as claimed in claim 1 wherein the rotational device includes:
an axle block fixed to a bottom of the motor and coupled with a rotational shaft of the motor, the axle block including an engaging groove in a bottom thereof;
a fixing block including a hollow portion, the fixing block being fixed to the axle block and including a protrusion securely engaged in the engaging groove of the axle block, the fixing block further including a plurality of holes;
a support screw including an upper end received in the hollow portion of the fixing block;
a swaying member including a hollow disc having a flange on an outer periphery thereof, the flange including a plurality of through-holes, with screws extending through the through-holes of the flange into the holes in the fixing block, the swaying member including an arcuate plate on a bottom thereof, the arcuate plate including a plurality of arcuate ribs; and
a swaying seat including a hollow disc having a bowl-like compartment in an upper portion thereof, a plurality of arcuate grooves being defined in an inner peripheral wall defining the bowl-like compartment, the arcuate plate of the swaying member being received in the bowl-like compartment of the swaying seat, with the arcuate ribs being slidably received in the arcuate grooves of the swaying seat;
with the support screw extending through the swaying member and the swaying seat and having an exposed section outside the swaying seat, with a washer and a nut mounted to the exposed section to allow the support screw to be fixed to the vehicle.

3. The illuminating device for a vehicle as claimed in claim 2 further comprising a buffering device in a bottom portion of the swaying seat.

4. The illuminating device for a vehicle as claimed in claim 3 wherein the buffering device includes upper and lower cushions in intimate contact with each other and made of soft, tough material.
